(19) United States
(12) Patent Application Publication
(10) Pub. No.: US 2024/0029031 A1
(43) Pub. Date: Jan. 25, 2024

(54) MACHINE LEARNING RECOMMENDATION FOR MAINTENANCE TARGETS IN PREVENTIVE MAINTENANCE PLANS

(71) Applicant: SAP SE, Walldorf (DE)

(72) Inventors: Niranjan Raju, Bengaluru (IN); Sagarika Mitra, Bangalore (IN); Meby Mathew, Kochi (IN); Radhakrishna Aekbote, Hubli (IN); Shirish Totade, Bangalore (IN)

(73) Assignee: SAP SE, Walldorf (DE)

(21) Appl. No.: 17/872,822

(22) Filed: Jul. 25, 2022

(51) Int. Cl. G06Q 10/00

(52) U.S. Cl. CPC G06Q 10/20

(57) ABSTRACT

Automated management of tasks in a preventive maintenance context supports associating preventive maintenance targets with a preventive maintenance task. A trained machine learning model can predict which targets are most likely to be appropriate for a given header preventive maintenance target. A user interface can assist in target selection. Data integrity can be improved, and unnecessary expenditure of preventive maintenance resources can be avoided. A trained machine learning model can support features such as filtering and identifying outliers.

### FIELD

The field generally relates to machine learning in a preventive maintenance context.

### BACKGROUND

Although hidden from most consumers, maintenance is an essential part of our modern technology-driven economy. Different organizations may manage different assets in different ways, but they uniformly face a common problem in maintaining such assets. Preventive maintenance is preferred over reactive maintenance because reactive maintenance typically does not take place until there is a failure, which leads to increased costs for repairing equipment as well as loss of production during downtime. By contrast, a well-orchestrated preventive maintenance program can reduce costs, avoid interruptions, and even save lives.

Today's automated preventive maintenance programs can address many issues of managing the preventive maintenance process. However, due to the details regarding preventive maintenance as actually carried out, there remain various issues with creating and configuring automated preventive maintenance in practice.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a computer-implemented method comprises receiving a request for a list of one or more preventive maintenance task target candidates to be assigned to a specified header preventive maintenance task target; responsive to the request, generating a list of one or more predicted preventive maintenance task targets for assignment to the specified header preventive maintenance task target, wherein at least one of the predicted preventive maintenance task targets is predicted by a machine learning model trained with observed header preventive maintenance task targets and observed preventive maintenance task targets stored as assigned to respective of the observed header preventive maintenance task targets; and outputting the list of the one or more predicted preventive maintenance task targets for assignment in response to the request.

In another embodiment, a computing system comprises at least one hardware processor; at least one memory coupled to the at least one hardware processor; a stored internal representation of preventive maintenance tasks to be performed on maintenance task targets; a machine learning model trained with observed header preventive maintenance task targets and preventive maintenance task targets observed as assigned to respective of the observed header preventive maintenance task targets; and one or more non-transitory computer-readable media having stored therein computer-executable instructions that, when executed by the computing system, cause the computing system to perform: receiving a request for a list of one or more preventive maintenance task target candidates to be assigned to a specified header preventive maintenance task target; responsive to the request, generating a list of one or more predicted preventive maintenance task targets for assignment to the specified header preventive maintenance task target, wherein at least one of the predicted preventive maintenance task targets is predicted by the machine learning model trained with observed header preventive maintenance task targets and observed preventive maintenance task targets assigned to respective of the observed header preventive maintenance task targets; and outputting the list of the one or more predicted preventive maintenance task targets for assignment in response to the request.

In another embodiment, one or more non-transitory computer-readable media comprise computer-executable instructions that, when executed by a computing system, cause the computing system to perform operations comprising: for a specified header preventive maintenance task target to which a represented preventive maintenance task is directed, receiving a request for one or more preventive maintenance task target candidates to be included with the specified header preventive maintenance task target; applying the specified header preventive maintenance task target and an equipment class of the specified header preventive maintenance task target to a machine learning model; receiving a prediction from the machine learning model, wherein the prediction comprises one or more proposed preventive maintenance task targets predicted to be associated with the specified header preventive maintenance task target; displaying at least a subset of the proposed preventive maintenance task targets predicted to be associated with the specified header preventive maintenance task target; receiving a selection of one or more selected proposed preventive maintenance task targets out of the displayed proposed preventive maintenance task targets; and storing an association between the selected proposed preventive maintenance task targets and the represented preventive maintenance task, thereby adding the selected proposed preventive maintenance task targets as targets of the represented preventive maintenance task.

As described herein, a variety of other features and advantages can be incorporated into the technologies as desired.

### BRIEF DESCRIPTION OF THE DRAWINGS

FIG. 1 is a block diagram of an example system implementing machine learning recommendation for preventive maintenance targets in preventive maintenance plans.

FIG. 2 is a flowchart of an example method of implementing machine learning recommendation for preventive maintenance targets in preventive maintenance plans.

FIG. 3 is a block diagram of an example internal representation of a preventive maintenance plan.

FIG. 4 is a block diagram showing an example system training a machine learning model for machine learning recommendation for preventive maintenance targets.

FIG. 5 is a flowchart of an example method of training a machine learning model for machine learning recommendation for preventive maintenance targets.

FIG. 6 is a block diagram of an example system predicting proposed targets via a trained machine learning model.

FIG. 7 is a flowchart of an example method predicting proposed targets via a trained machine learning model.

FIG. 8 is a block diagram of an example system filtering targets based on validity segments.

FIG. 9 is a flowchart of an example method of filtering targets based on validity segments.

FIG. 10 is a flowchart of an example method of flagging outlier targets.

FIG. 11 is a block diagram of an example entity diagram of an architecture implementing the described features.

FIG. 12 is a block diagram of an example user interface implementing machine learning recommendation for preventive maintenance targets.

FIG. 13 is a block diagram of an example recommendations format.

FIG. 14 is a block diagram of another example recommendations format.

FIG. 15 is a block diagram of an example machine-learning-based object list diagram of an architecture implementing the described features.

FIG. 16 is a block diagram of an example machine-learning-based object list diagram of an architecture implementing the described features showing additional detail.

FIG. 17 is a block diagram of an example computing system in which described embodiments can be implemented.

FIG. 18 is a block diagram of an example cloud computing environment that can be used in conjunction with the technologies described herein.

### DETAILED DESCRIPTION

### Example 1—Overview

Automated preventive maintenance programs can greatly simplify and improve execution of preventive maintenance. For example, such a program can implement a process where maintenance plans are defined to track the various tasks associated with the preventive maintenance process. In practice, an original equipment manufacturer can provide a suggested plan to ease the configuration process. The plan can then be used as-is or customized and stored internally in a computing system as a preventive maintenance plan (or simply “maintenance plan”).

The various tasks of the maintenance plan can be represented as task nodes and stored with associated targets of the tasks. A so-called “header” target (e.g., a piece of equipment) can be a main target associated with a task. Other targets can be stored as associated and are typically targets that are somehow related to the header target in a stored hierarchy of targets.

Subsequently, the targets are stored as targets of a particular maintenance task that is represented in configuration information. As a result, whenever a preventive maintenance order is created as part of execution of the preventive maintenance plan, the targets specified by the user are included in the preventive maintenance order. A worker then proceeds to physically perform the maintenance work on the specified targets.

However, in practice, when configuring preventive maintenance tasks, users sometimes choose an arbitrary target that is not stored as associated with the header target. Such a component may represent a target that is known by the user to be best included with the task, even though such a relationship is not stored in a hierarchy of targets.

Adding such arbitrary targets to a maintenance task conventionally requires manual selection (e.g., not chosen from a list of candidate targets). Thus, when a new plan is defined, users apply their personal experience to determine which targets should be included into the context of maintenance of a particular piece of equipment and select them manually.

In practice, because there is no restriction of selection possibilities to a fixed set (e.g., non-related targets can be added), a user can add any arbitrary target, which then subsequently ends up on a maintenance order.

From a data governance perspective, such an approach is a challenge because verifying whether a target should be in a list is difficult. Data integrity is thus not guaranteed. If a mistake is made, it can lead to confusion and/or maintenance execution on an irrelevant piece of equipment, now and in the future. For example, maintenance may be performed based on an order generated from the list, and maintenance costs can be increased when repair work is unnecessarily done on an unrelated piece of equipment.

Instead, a machine-learning-based approach can provide a recommendation for targets to be added. Given a header target, a machine language model can predict the most likely targets. A list of candidate targets in a recommendations list can be proposed. A confidence score or relevance factor (e.g., percentage) can be included. Thus, even targets that are unrelated in the hierarchy can be rated based on how likely they are predicted to appear. The list can be ordered by confidence score to emphasize the most likely targets. As described herein, candidates can be filtered to remove dismantled items.

Other techniques such as identifying outliers can be used as described herein.

The described technologies thus offer considerable improvements over conventional automated preventive maintenance techniques.

### Example 2—Example System Implementing Machine Learning Recommendation for Maintenance Targets in Preventive Maintenance Plans

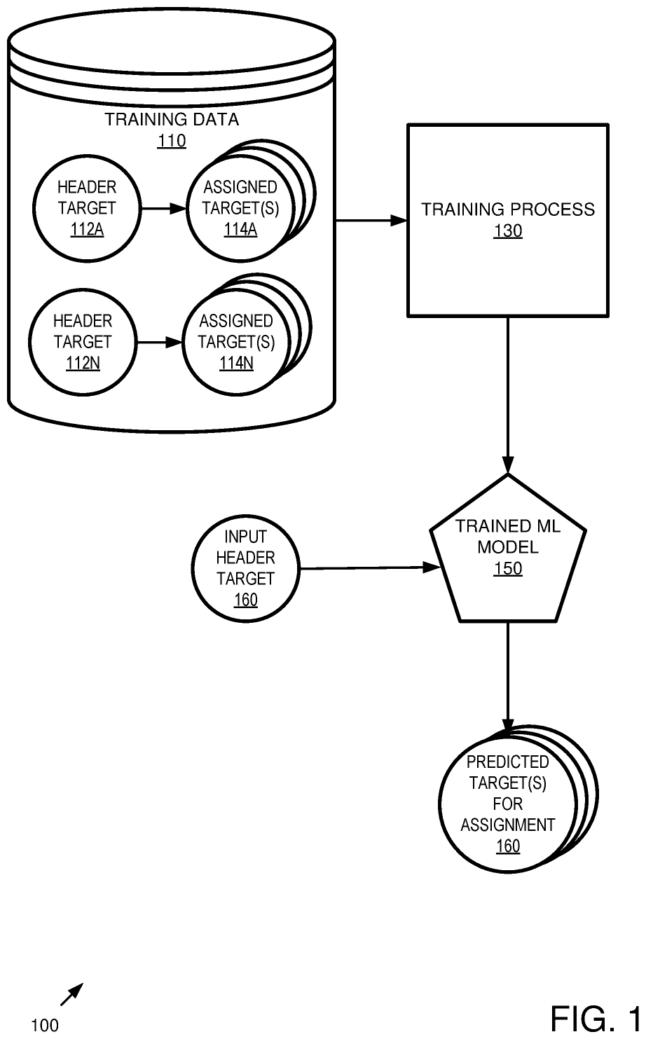

FIG. 1 is a block diagram of an example system 100 implementing machine learning recommendation for maintenance targets in preventive maintenance plans. In the example, the system 100 can include training data 110 that comprises a first header preventive maintenance task target 112A and one or more assigned preventive maintenance task targets 114A (e.g., assigned to the header target 112A by virtue of being targets of the same task). The training data 110 includes additional header preventive maintenance task targets and respective assigned targets, such as header 112N and assigned target(s) 114N. In practice, the training data 110 can be a stored internal representation of preventive maintenance tasks to be performed on maintenance task targets. For example, the header target 112A and the assigned targets 114A can be targets of the same internally represented preventive maintenance task. The machine learning model 150 is thus trained with observed (e.g., historical) header preventive maintenance task targets and preventive maintenance task targets assigned to respective of the header preventive maintenance task targets (e.g., by virtue of the header target and assigned targets both being targets of the same preventive maintenance task).

Any of the systems herein, including the system 100, can comprise at least one hardware processor and at least one memory coupled to the at least one hardware processor.

The training data 110 is used as input to a training process 130 that produces a trained machine learning model 150, which accepts an input header target 160 and generates one or more predicted targets 160 for assignment to the input header target 160 (e.g., recommended to be assigned to the same task of which the input header target is a target).

As described herein, the predicted targets 160 can be recommended to be assigned to the header target 160 or compared to what is already stored as assigned to identify outliers that are possible assignment errors. In practice, the predicted targets 160 can include respective confidence scores that help identify those most likely targets for assignment, misassigned targets, or the like.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, the training data 110 can include significantly more training data and test data so that predictions can be validated. There can be additional functionality within the training process. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the training data 110, trained model 150, and the like can be stored in one or more computer-readable storage media or computer-readable storage devices. The technologies described herein can be generic to the specifics of operating systems or hardware and can be applied in any variety of environments to take advantage of the described features.

### Example 3—Example Method Implementing Machine Learning Recommendation for Maintenance Targets in Preventive Maintenance Plans

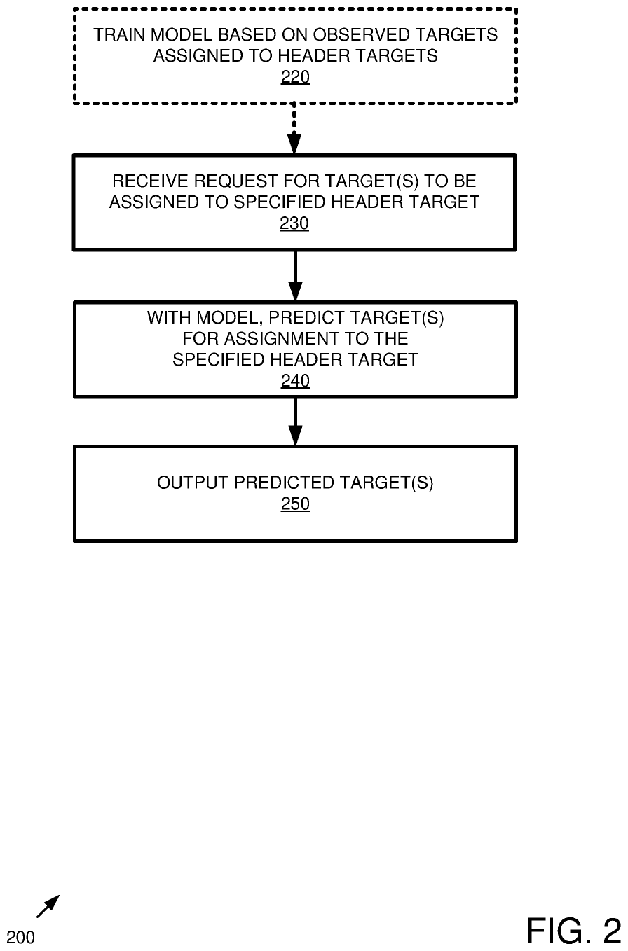

FIG. 2 is a flowchart of an example method 200 of machine learning recommendation for maintenance targets in preventive maintenance plans and can be performed, for example, by the system of FIG. 1. The automated nature of the method 200 can be used in a variety of situations such as assisting in assigning targets to a task, checking whether a target has been mistakenly assigned to a task, or the like.

In the example, at 220, a machine learning model is trained based on preventive maintenance task targets observed as assigned to header preventive maintenance task targets (e.g., historical data). In practice, a method implementing the technologies can be implemented without 220 because the training can be done in advance (e.g., at another location, by another party, or the like). The machine learning model can be trained with a header preventive maintenance task targets and preventive maintenance task targets structured during the training as assigned to each other when in a same internally represented maintenance task.

At 230, a request for one or more targets to be assigned to a specified (e.g., input) header target is received. For example, in an assignment user interface context, the header target specified in the user interface can be used. The request can be a request for one or more preventive maintenance task target candidates to be assigned to a specified header preventive maintenance task target (e.g., a request for a recommendation list). In practice, the header and the assigned targets are both targets of the same task (e.g., internally represented as a task node).

At 240, one or more predicted targets for assignment to the specified header target can be predicted with a machine learning model. In practice, responsive to the request of 230, a list of one or more predicted preventive maintenance task targets for assignment to the specified header preventive maintenance task target can be generated (e.g., a recommendation list). At least one of the predicted preventive maintenance task targets can be predicted by a machine learning model trained with observed (e.g., historical) header preventive maintenance task targets and observed preventive maintenance task targets stored as assigned to respective of the observed header preventive maintenance task targets (e.g., both the header and assigned target are observed to be targets of the same task). As described herein, predictions can be computed in advance and stored as table views.

As described herein, a header preventive maintenance task target and preventive maintenance task targets can be structured as assigned to each other (e.g., deemed assigned to each other during training) when in (e.g., the target of) a same internally represented preventive maintenance task. Such structure can be accomplished by a stored reference from a header target to assigned targets, or by a stored reference from a task to both the header target and assigned targets. Other arrangements are possible (e.g., reverse references).

As described herein, such targets can be filtered based on confidence score. Dismantled targets can be filtered out. In an assignment user interface context, the predicted targets (e.g., a filtered list) can be displayed for consideration for assignment.

In any of the examples, the prediction can be made beforehand (e.g., before the request at 230). For example, pre-computed predictions can be stored in a table or other data structure and retrieved from the table at the time of the request.

At 250, the one or more predicted targets are output. Such targets can be predicted preventive maintenance task targets for assignment, and the output can be performed responsive to the request of 230. The machine learning model can output a confidence score of a particular target that the particular target would be assigned to a particular header target. For example, the predicted targets can be displayed as candidate targets in a user interface as a recommendation list for selection as actual assigned targets.

As described herein, such predicted targets (e.g., or selected ones) can then be assigned to the header target, or already-assigned targets can be checked to identify likely errors in assignment.

In a supervisory use case, the method can further comprise receiving a list of one or more particular preventive maintenance task targets assigned to a particular header target. For a given particular target out of the targets, a confidence score computed by a trained machine learning model can be compared against a confidence score threshold. For example, a low cut off score can be set. Targets that do not meet the low cut off score can be deemed to be likely errors. The particular targets not meeting the threshold can be output as outliers.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving a request can be described as sending a request depending on perspective.

### Example 4—Example Machine Learning Model

In any of the examples herein, a machine learning model can be used to generate predictions based on training data. In practice, any number of models can be used. Examples of acceptable models include random decision tree, decision tree (e.g., binary decision tree), random decision forest, Apriori, association rule mining models, and the like. Such models are stored in computer-readable media and are executable with input data to generate an automated prediction.

### Example 5—Example Confidence Score

In any of the examples herein, the trained machine learning model can output a confidence score with any predictions. Such a confidence score can indicate how likely it would be that the particular target would be assigned to a given header target. Such a confidence score can indicate the relevance of a predicted target for a given header target. The confidence score can be used as a rank to order predictions.

Also, as described herein the confidence score can help with filtering. For example, the score can be used to filter out those targets with low confidence scores (e.g., failing under a specified low threshold or floor).

Confidence scores can also be used to color code displayed targets (e.g., using green, yellow, red to indicate high, medium, or low confidence scores).

### Example 6—Example Internal Representation of Preventive Maintenance Plan

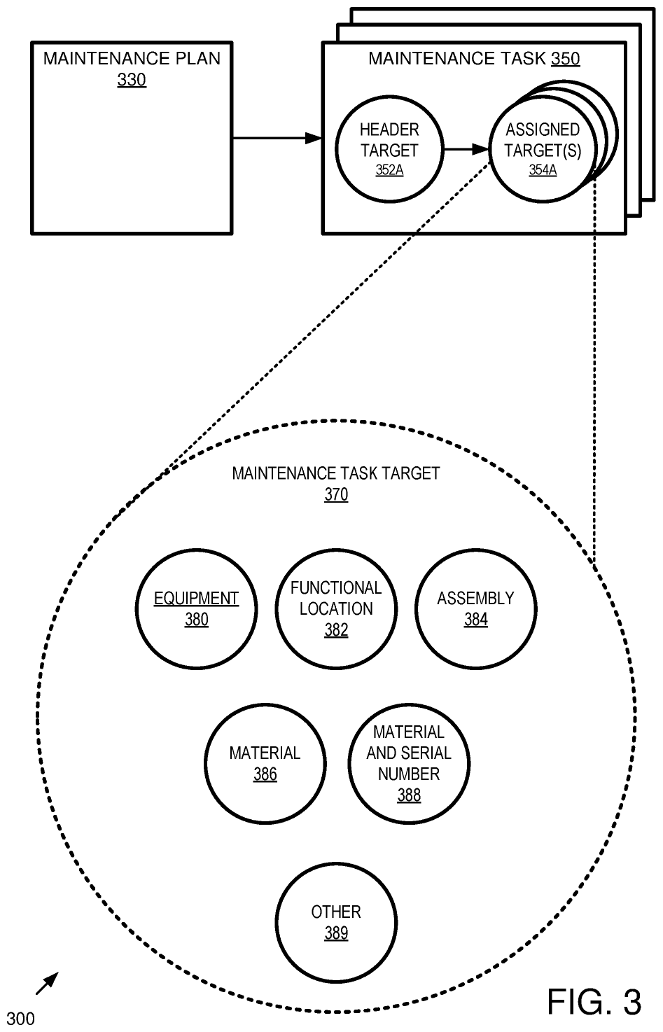

FIG. 3 is a block diagram of an example internal representation 300 of a preventive maintenance plan. Such a plan can comprise one or more maintenance plan nodes 330 (or simply “plans”) that describe the maintenance and inspection tasks to be performed at maintenance objects. A maintenance task node 350 (or simply “maintenance task” or “item”) describes which maintenance task(s) should take place regularly at one or more target nodes (or simply “targets,” “technical objects,” or “objects”).

For example, a maintenance task 330 could represent the task of “perform safety test.” The target nodes 352A and 354A are assigned to the task 350 to reflect on what or where the task is to be performed. The target nodes 352A and 354A are called “targets” herein because they can be described as the target of the represented task 350 (e.g., the task is directed to the targets).

The maintenance task 350 includes at least one header target 352 (sometimes called a “reference” target). One or more additional targets 354 can be assigned to the task 350. The maintenance operations that are defined for a maintenance task (e.g., linked to a maintenance task list) are designated as due for the targets assigned. In the example, at least one node 354A has been assigned as a result of machine learning model prediction. However, some instances can involve targets that are assigned manually.

As shown, in any of the examples herein, a target (e.g., assigned target 354A) can comprise a represented piece of equipment 380, functional location 382, assembly 384, material 386, material and serial number 388, or the like 389. A generic data structure for representing any of the targets can be used to store targets.

When the maintenance plan 330 is executed (e.g., according to a stored schedule), the system generates appropriate tasks and targets for the defined cycles. For example, a maintenance order or maintenance notification can be generated, which is then carried out on or at the physical targets.

Planned maintenance can be a generic term for inspections, preventive maintenance, and planned repairs, for which the time and scope of the work can be planned in advance.

### Example 7—Example Integration into ERP Software

In any of the examples herein, the technologies can be integrated into enterprise resource planning (“ERP”) software. For example, SAP S/4 Maintenance Management can incorporate the features of planned maintenance to ensure timely maintenance and therefore high availability of assets.

### Example 8—Example Preventive Maintenance

In any of the examples herein, preventive maintenance can help avoid system breakdowns or the breakdown of other objects, which in addition to the repair costs, often results in much higher overall costs due to associated production breakdown.

### Example 9—Example Preventive Maintenance Task

In any of the examples herein, a preventive maintenance target can take the form of an object representing a preventive maintenance task. For example, the task can be a set of instructions to be carried out on one or more targets as described herein. The internal representation of the task can include a task identifier, description of the task, task details, links to targets, specified spare parts (e.g., screws, bolts, grease can, or the like), links to external services (e.g., where a service provider visits the site and executes the maintenance job on behalf of the customer), and the like.

### Example 10—Example Preventive Maintenance Task Target

In any of the examples herein, a preventive maintenance task target can take the form of an object to which a maintenance task is directed. For example, the target can be a piece of machinery being maintained, a location being maintained, an assembly being maintained, or the like.

In practice, maintenance task targets can be implemented as objects in data with fields that indicate details regarding the target. For example, a piece of machinery being maintained can include a class or type of equipment, a serial number, start date, and other details.

When used for training or prediction, an identifier can be used (e.g., a target identifier) to represent a target. Similarly, a class or type can be used (e.g., a target class, target type, or the like).

For example, a location being maintained can be represented by an object storing location, organization, structure, and the like. A unique identifier for such a location can be implemented using a coding template and hierarchy levels that indicate details such as plant, department, location (e.g., room section, or the like), sub department, operating area, and the like. Thus, different portions of the identifier can indicate a hierarchical relationship (e.g., a plant can have more than one department, a department can have more than one location, a department can have more than one operating area, and the like).

### Example 11—Example System Training a Machine Learning Model for Machine Learning Recommendation for Maintenance Targets

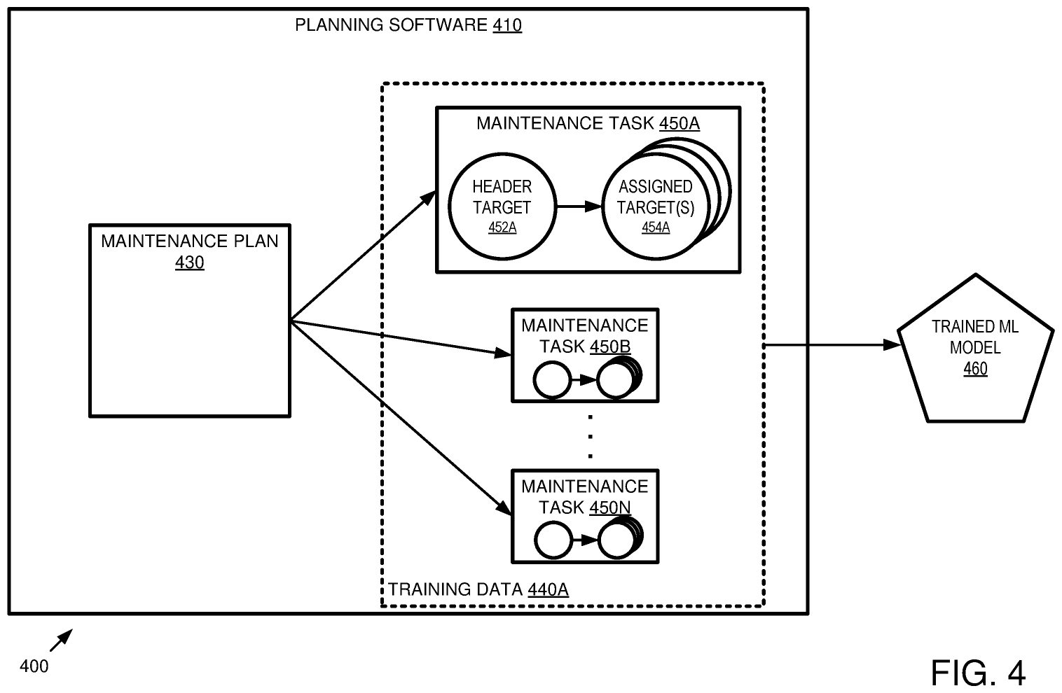

FIG. 4 is a block diagram showing an example system 400 training a machine learning model 460 for machine learning recommendation for maintenance targets and can be used in any of the examples herein. In the example, planning software 410 stores a maintenance plan 430 that has one or more associated maintenance tasks 450A-N. As shown, a given maintenance task 450A has at least one header target 452A and can support one or more assigned additional targets 454A. For purposes of convenience, the additional targets 454A are sometimes described as assigned to the header target 452A.

The stored data representing associations between the header targets 452A and assigned targets 454A can be used as input to a training process that produces the trained model 460.

In practice, the planning software 410 can include create, retrieve, update, and delete functionality or the like to maintain one or more maintenance plans. A user interface can be provided by which users can specify the additional assigned targets 454A.

The training data need not come from the same software instance that uses the trained machine learning model 460. For example, the system 410 can be implemented in a multi-tenant environment that takes advantage of training data available across consenting tenants.

### Example 12—Example Training Data

In any of the examples herein, training data can come from a variety of sources. In additional to observed (e.g., historical) data showing past target assigned (e.g., as currently stored in maintenance plans), data from historical maintenance orders, historical maintenance notifications, purchase orders, bills of material, and the like can be included. Technical objects stored as related to observed data can also be included. Such technical objects can include representations of equipment, functional locations, assemblies, serialized material, or the like.

Observed data is sometimes called “historical” because it reflects a past assignment that can be observed and leveraged for training purposes. For example, if a currently stored task has an observed header and one or more observed targets, the observed header and the observed targets can be used for training purposes. They targets represent an historical assignment that took place in the past and is a reasonable indication of possible future assignments. Thus, the model can generate a recommendations list as described herein based on such observed, historical assignments that were made in the past.

As described herein, training can proceed using the header target as an independent feature and the assigned targets as a dependent feature. Thus, the trained machine learning model can predict assigned targets based on an input header target. In practice, the model can predict a list of targets with respective confidence scores or simply generate a confidence score for a given target (e.g., in light of the input header target).

Additional features can be included in the training data (e.g., a task identifier or the like). Predictions can thus be based on the same features (e.g., a header target and a task identifier).

In the training process, the training data can specify an actual physical piece of equipment, an equipment description, an equipment type, an equipment class, or the like. For example, training can use equipment descriptions so that target descriptions are recommended when the machine learning model predicts them based on a header description. Similarly, Training can use equipment classes so that target classes are recommended when the machine learning model predicts them based on a header class. As described herein, functional locations can also be included and treated similarly (e.g., using an actual functional location, a functional location type, a functional location class, or the like).

Subsequent to training, the model generally predicts the most commonly used targets, given a particular header target.

Examples can be implemented in which only the actual equipment instance (e.g., 1001110, 2322110, FLOC-ABC-DEF) is considered. For example, description need not be used as input to the model but can be. Further, to improve predictive power or accuracy, the class (e.g., equipment class such as CENTRIFUGAL-PUMP), the object type (e.g., equipment type such as 9200—Pumps, 9300—motor, 9400—valves), or the like can be used as input parameters. Training can proceed with such parameters. After training, a prediction can be generated by inputting the same input parameters to generate a prediction.

### Example 13—Example Method of Training a Machine Learning Model for Machine Learning Recommendation for Maintenance Targets

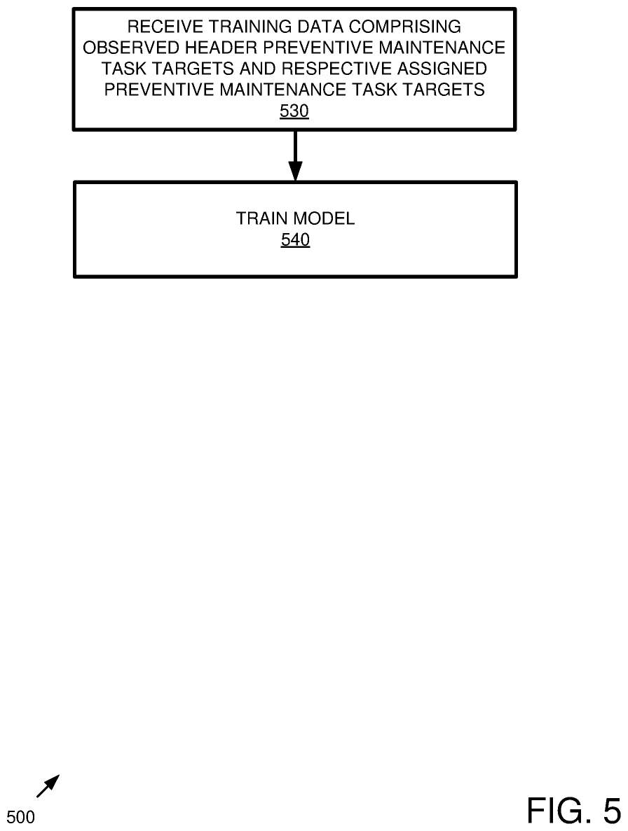

FIG. 5 is a flowchart of an example method 500 of training a machine learning model for machine learning recommendation for maintenance targets and can be implemented in any of the examples herein (e.g., the system shown in FIG. 4).

At 530, training data comprising observed header preventive maintenance task targets and respective assigned preventive maintenance task targets is received. As described herein, the header target and assigned targets can be structured during the training as assigned to each other when in a same internally represented maintenance task (e.g., the same task has them, they are linked to the same task, they are targets of the same task, or the like).

At 540, the model is trained using the training data. For example, training can proceed using the header target as an independent feature and the assigned targets as dependent features. Validation can proceed to verify that the model is generating meaningful predictions.

### Example 14—Example Training Process

In any of the examples herein, training can proceed using a training process that trains the model using available training data. In practice, some of the data can be withheld as test data to be used during model validation.

Such a process typically involves feature selection and iterative application of the training data to a training process particular to the machine learning model. After training, the model can be validated with test data. An overall confidence score for the model can indicate how well the model is performing (e.g., whether it is generalizing well).

In practice, machine learning tasks and processes can be provided by machine learning functionality included in a platform in which the system operates. For example, in a database context, training data can be provided as input, and the embedded machine learning functionality can handle details regarding training.

If the data volume is too high, the model can be trained in a side-by-side mode on another system instead of performing training within the same instance as the one where the model will be consumed for production.

### Example 15—Example System Predicting Proposed Targets Via Trained Machine Learning Model

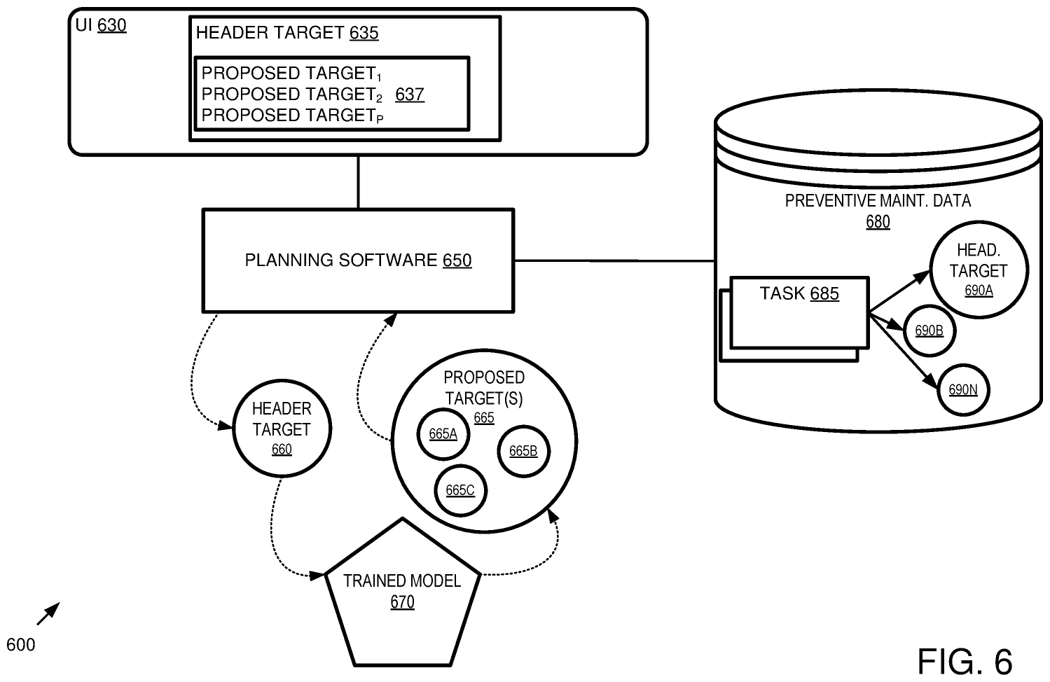

FIG. 6 is a block diagram of an example system 600 predicting proposed targets 665 via a trained machine learning model 670. In the example, planning software 650 presents a user interface 630 displaying user interface elements showing a header target 635 (e.g., for a preventive maintenance task). As a result of applying the trained model 670, the proposed targets 637 are shown for selection by the user as targets possibly to be assigned to the same task as the header target 635. For example, the targets 637 can be presented as a recommendation list. The user interface 630 accepts a selection of the proposed targets 637 for actual assignment. As described herein, the proposed targets 637 can be filtered to remove those with low confidence scores, dismantled equipment, or the like.

The planning software 650 is configured to output the header target 660 to the trained model 670 and receive proposed targets 665 in response, which originate from the trained model 670. In practice, additional input features can be provided as described herein.

As described herein, the proposed targets 665 can be pre-computed and stored in a table or other structure to allow rapid look up. For example, a query can specify the header target 660, and the proposed targets 665 are produced as query results.

Upon selection of the desired proposed targets 637 (e.g., in the user interface 630), the preventive maintenance data 680 can be updated accordingly. For example, for a task 685 having the header target 690A (e.g., the header target 635 shown in the user interface 630), the selected proposed targets 637 can be stored as assigned targets 690B, 690N in the data 680.

Accordingly, when maintenance orders or notifications for the task 685 can include the targets 690B, 690N (e.g., which were selected from the proposed targets 637).

### Example 16—Example Method Predicting Proposed Targets Via a Trained Machine Learning Model

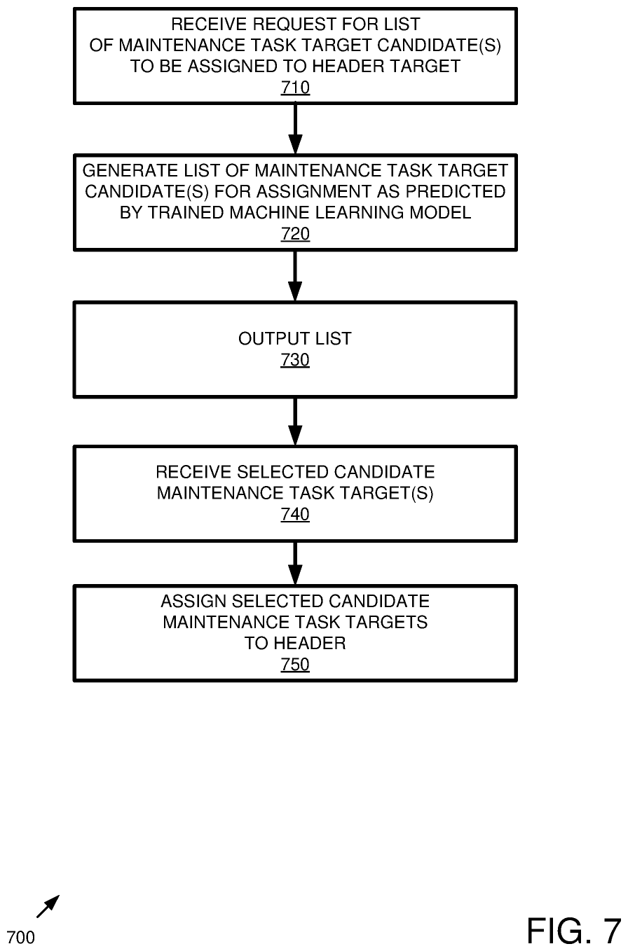

FIG. 7 is a flowchart of an example method 700 predicting proposed targets via a trained machine learning model and can be performed, for example, by the system of FIG. 6.

At 710, a request for a list of preventive maintenance task target candidates to be assigned to a header target can be received. In practice, the request comprises an indication of the header target.

At 720, a list of one or more preventive maintenance task target candidates for assignment are generated. Such candidates can come from predictions from a machine learning model trained as described herein. For example, the machine learning model can predict which targets are candidates for a particular header, and the generated list can incorporate such targets. In practice, the list can be filtered on a confidence score. For example, only those candidates have a confidence score over a specified threshold are included on the list. Such a confidence score can be fixed or configurable.

The machine learning model can accept the header target as an input. Further inputs such as class (e.g., equipment class) and object type of the header target can be used as inputs to the model. Application of such inputs to the machine learning model results in a prediction from the machine learning model.

At 730, the list is output. As described herein, the list can be displayed for consideration by a user, used to assess likelihood of error, or the like. In practice, the list can be combined with other sources of assignment candidates (e.g., based on a stored hierarchy, purchase orders, bills of material, or the like). The source of the candidates can be included in the displayed list. To assist in selection, a confidence score (e.g., percentage, rating, color, or the like) can be displayed proximate a candidate. Candidates can be ranked by confidence score.

At 740, one or more selected candidate preventive maintenance task targets can be received. For example, a user interface may receive a selection from the displayed candidates. In practice, a manual override process can be supported by which a target that does not appear in the list can be specified. Such a target can then be included in future training and appear as a candidate in the future.

At 750, responsive to receiving the selected candidates, the selected candidates can be assigned to the header (e.g., assigned to the same task as the header). As a result, when future maintenance orders or notifications are generated, the selected candidates can be included.

Linking such a method to that shown in FIG. 2, the specified header preventive maintenance task target can be of a task of a user interface configured to assign one or more preventive maintenance task targets to the task based on the specified header preventive maintenance task target. In such a context, the method can further display the list of the one or more predicted preventive maintenance task targets in the user interface as recommended (e.g., in a recommendations list). A selection of one or more selected preventive maintenance task targets out of the one or more predicted preventive maintenance task targets can be received (e.g., via the user interface). Then, the one or more selected preventive maintenance task targets can be assigned to the task of the user interface.

As described herein, the list of the predicted targets in the user interface can indicate whether a given displayed target is based on (e.g., appears because of) history or class.

As described herein, generating the list can comprise filtering the list with a threshold confidence score.

As described herein, generating the list can comprise ranking the list by confidence score.

As described herein, the list can be filtered. The filtering can remove dismantled predicted targets. Such filtering can be performed via validity segments.

As described herein, a manually-entered target not on the list can be received and assigned to the task of the user interface.

As a result of the method, benefits associated with more reliable and less error-prone target assignment can be achieved.

### Example 17—Example Target Recommendations

In any of the examples herein, machine learning can be used to generate a recommendation list. Such a list can comprise targets that are predicted to be assigned to a given header target. In practice, such targets can be called “recommended,” “proposed,” “candidate,” “relevant,” “likely,” or the like. As described herein, additional targets can be included in the recommendation list that come from other sources.

### Example 18—Example System Filtering Targets Based on Validity Segments

A complex system or machinery can comprise multiple pieces of equipment that work together within the boundaries of the system. In such cases, pieces of equipment can be installed underneath other pieces to form a functional hierarchy. A piece of equipment can be designated as having a lifetime; after the lifetime ends, the equipment can be dismantled and discarded or dismantled and repaired/refurbished and put back into action. The period between the installation and dismantling from the superordinate equipment can be represented as a validity period of the equipment. Such information can be stored in a database in the form of time segments.

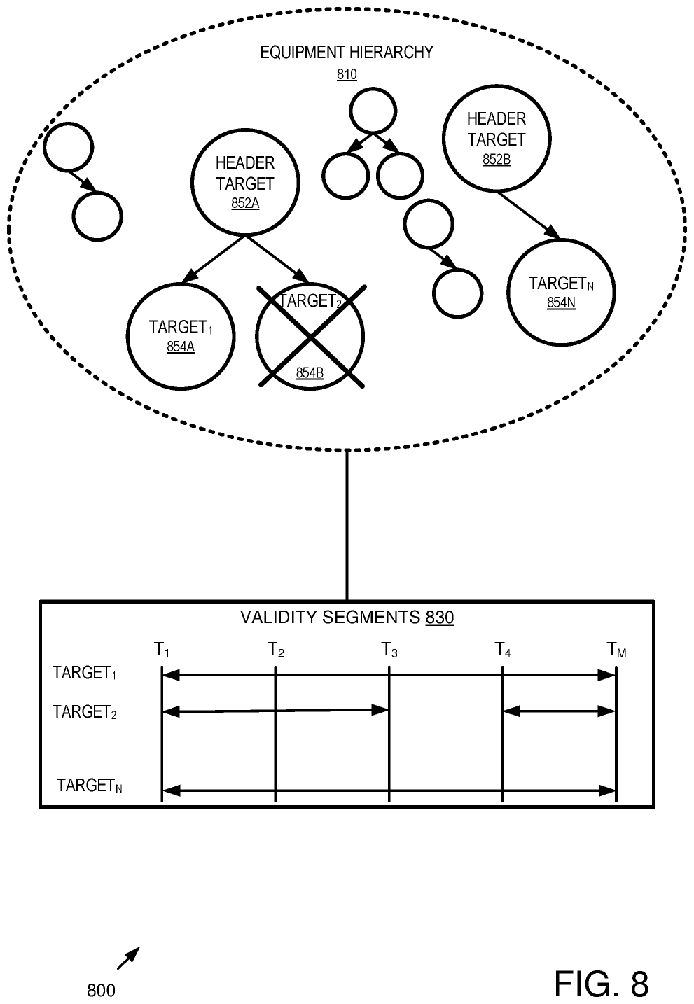

FIG. 8 is a block diagram of an example system 800 filtering targets based on validity segments 830. In the example, equipment is represented in an equipment hierarchy 810. For example, the header target 852A is associated with inferior targets 854A, 854B and header target 852B is associated with inferior target 854N.

In the example, the validity segments 830 show the times at which the target 854B is valid. During the lifecycle of a represented target, the target may be dismantled, installed under another hierarchy, or both. The target may be deactivated (e.g., if it is to be scrapped and is therefore unusable).

When a piece of equipment is dismantled from the superior equipment (e.g., a header target), a subsequent addition of the superior equipment as a header of a task can result in showing the dismantled equipment (e.g., due to the historical relationship). Accordingly, maintenance orders can be created with the dismantled equipment still showing in the object list, even though it is not part of the physical structure any longer.

Targets that have been dismantled or deactivated can be removed from recommended (e.g., candidate) targets.

So, for example, if target 854B is dismantled or deactivated, it can be removed from any list of candidate targets described herein.

When a piece of equipment (e.g., 854B) is part of a system that is being maintained, the equipment can appear in the recommendation list with a confidence score. However, when the piece of equipment is dismantled (e.g., moved to another system), it may not make sense for the equipment to appear in the recommendation list (e.g., is it not available anyway).

Thus, a special consideration can be made for the time-segment aspect of the equipment. So, when a new maintenance plan is created for the system, the results of the machine learning model prediction can be filtered to remove any pieces of equipment that were installed in the past but are not part of the hierarchy anymore. For example, when generating a recommendation list, the list can be filtered to remove such targets.

For example, if the new maintenance plan is created at a time between T₃ and T₄, Target₂ 854B can be filtered according to the validity segments 830.

In practice, a piece of equipment can be permanently or temporarily dismantled. Internal representation of the validity segments 830 can be adjusted accordingly.

### Example 19—Example Method of Filtering Targets Based on Validity Segments

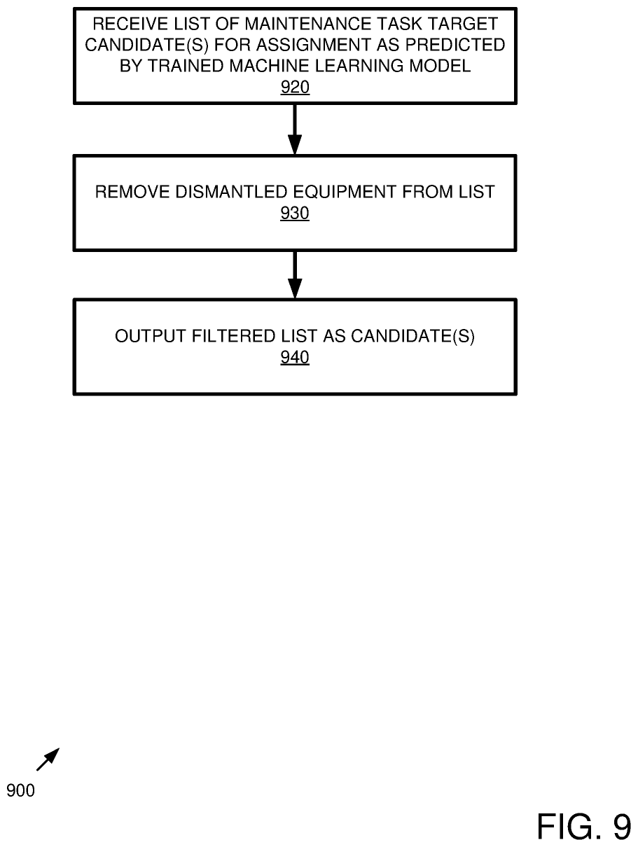

FIG. 9 is a flowchart of an example method 900 of filtering targets based on validity segments and can be implemented, for example, by a system such as that shown in FIG. 8.

At 920, a list of one or more maintenance task target candidates for assignment as predicted by a trained machine learning model is received.

At 930, dismantled equipment is removed from the list (e.g., the list is filtered). As described herein, a determination of whether equipment is currently dismantled can be based on whether the current time is within a validity segment.

At 940, the filtered list is output as the one or more candidates for use in any of the examples described herein (e.g., for selection from a user interface or the like).

### Example 20—Example Flagging Outlier Targets

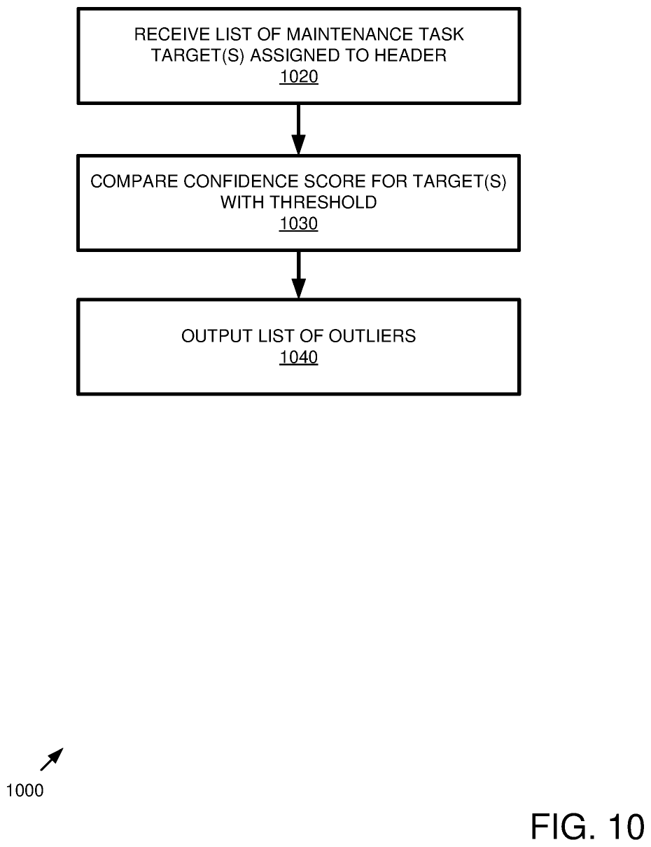

FIG. 10 is a flowchart of an example method 1000 of flagging outlier targets that can be used in any of the examples herein. In addition to or instead of presenting candidates for selection by a user interface, the technologies described herein can be used to flag outlier targets that are likely to be assigned to a task in error.

Use cases for such a technology include checking the integrity of the data (e.g., maintenance plans) generally and supporting a supervisory role that verifies maintenance orders or maintenance notifications before they are sent. The outlier identification can be combined with other factors. For example, if an outlier is also associated with unusually high expense (e.g., exceeds an expense threshold), it can be flagged as urgent for review and approval before the maintenance order or notification is sent.

At 1020, a list of maintenance task targets assigned to a header target (e.g., assigned to the same task as the header target) is received. The targets can be previously assigned (or suggested to be assigned) by a user or simply be currently assigned for whatever reason. For example, a currently stored maintenance plan can be checked via the method 1000 by using the headers and targets of the plan. Such targets are being investigated to determine whether they were assigned in error. For example, a supervisory role may be involved to check on the work of others. Such a supervisory function can be assisted by checking whether assigned targets are outliers (e.g., very unlikely to be properly assigned). For example, such targets can originate from a list of those targets recently assigned (e.g., assigned after the last check was done). Such targets can be placed in a queue and then analyzed on a periodic basis as part of the supervisory role.

At 1030, the confidence score for a given target on the list can be compared against a threshold (e.g., deemed to be too low) confidence score. If a given target does not meet the threshold, it can be designated as an outlier.

The process can cycle through the list and compare thresholds iteratively.

At 1040, the list of outliers is output. The particular preventive maintenance task targets not meeting the confidence score threshold can be output as outliers. Or, the processing can be used as a filter. Outliers can be automatically removed from assignment or placed on an exception list for consideration for removal, correction, or both.

### Example 21—Example Table Structure

In any of the examples herein, training data and predictions can be represented in table format. An actual table or a table view (e.g., a view that appears to be a table, whether or not an actual underlying table is stored) can be used. For example, a table format can facilitate simple interface with existing data sets. Some database management systems such as SAP HANA provide Core Data Services views that accommodate a wide variety of table-based functionality, including incorporating views into more complex and robust functional frameworks such as those leveraging machine learning models.

As an example, Table 1 shows example columns from a training view that comprises historical data related to targets. In some implementations, a “technical object” can be defined that subsumes equipment and functional location. The technical object can be defined generically so that it can represent both equipment and functional locations.

TABLE 1
Training View Fields

| | | Sample(s) of Data |
|---|---|---|
| Name | Description | (Internal representation) |
| HeaderEquipment | Equipment that is being | CFP-1001-DE |
| | maintained | |
| HeaderFunctionalLocation | Functional Location that is being | PUMP-CFP-DE-1001 |
| | maintained | |
| HeaderTechnicalObject | Technical Object that is being | EAMS_EQUI CFP-1001-DE |
| | maintained | |
| ObjectListTechnicalObject | List of technical objects that could | 10012322 (SKF Bearing) |
| | be related with the header | |
| | equipment that could be used for | CFP_SHAFT-1001 |
| | training of the model | (Serialized Material) |
| | | CFP_CHASSIS |
| | | (Material) |
| | | 900001 |
| | | (Bearing Serialised |
| | | Equipment) |
| | | 4002120 |
| | | (Power Unit Assembly) |
| | | 1090001 |
| | | (Power Display Unit) |
| | | X-11001-11 |
| | | (Dual Flow Control Valve) |

Table 2 shows example training data stored as a table view. In practice, the training data has more records. The header and targets are structured as assigned to each other by virtue of appearing in the same record. For example, multiple records can be used when there is more than one assigned target (e.g., and each record has the same header target).

TABLE 2
Example Training Data Set Excerpt

| Header- | Header-Functional- | | |
|---|---|---|---|
| Equipment | Location | HeaderTechnicalObject | ObjectListTechnicalObject |
| CFP-1001-DE | | EAMS_EQUI | EAMS_EQUI CFP-1001-DE |
| | | CFP-1001-DE | |
| | PUMP-CFP-DE-1001 | EAMS_FLOC PUMP- | 900001 |
| | | CFP-DE-1001 | (Bearing Serialised) |
| CFP-1002-DE | | EAMS_EQUI | 4002120 |
| | | CFP-1002-DE | (Power Unit Assembly) |
| CFP-1001-DE | | EAMS_EQUI | EAMS_EQUI CFP-1001-DE |
| | | CFP-1001-DE | |
| CFP-1003-DE | | EAMS_EQUI | 4002120 |
| | | CFP-1003-DE | (Power Unit Assembly) |
| CFP-1001-DE | | EAMS_EQUI | CFP_SHAFT-1001 |
| | | CFP-1001-DE | (Serialized Material) |
| | PUMP-CFP-DE-1001 | EAMS_FLOC | 1090001 |
| | | PUMP-CFP-DE-1001 | (Power Display Unit) |
| | PUMP-CFP-DE-1001 | EAMS_FLOC | 900001 |
| | | PUMP-CFP-DE-1001 | (Bearing Serialised) |
| | PUMP-CFP-DE-1002 | EAMS_FLOC | 4002120 |
| | | PUMP-CFP-DE-1002 | (Power Unit Assembly) |
| CFP-1001-DE | | EAMS_EQUI | EAMS_EQUI CFP-1001-DE |
| | | CFP-1001-DE | |
| | PUMP-CFP-DE-1001 | EAMS_FLOC | 900001 |
| | | PUMP-CFP-DE-1001 | (Bearing Serialised) |

As an example, Table 3 shows the fields in a predicted data view.

TABLE 3
Prediction View

| | | Sample(s) of Data |
|---|---|---|
| Name | Description | (Internal representation) |
| HeaderEquipment | Equipment that is being maintained | CFP-1001-DE |
| HeaderFunctionalLocation | Functional Location that is being | PUMP-CFP-DE-1001 |
| | maintained | |
| HeaderTechnicalObject | Technical Object that is being maintained | CFP-1001-DE |
| ObjectListTechnicalObject | List of technical objects that could be | 10012322 |
| | related with the header equipment that | (SKF Bearing) |
| | could be used for training of the model | CFP_SHAFT-1001 |
| | | (Serialized Material) |
| | | CFP_CHASSIS (Material) |
| Predict_Confidence | Rating of confidence level. E.g. 0.62 | 0.62, 0.84, 0.28 |
| | indicates 62% confidence. | |

As an example, Table 3 shows predicted data along with the prediction confidence. To use the data, a query or table scan can be done on the view.

TABLE 4
Prediction View

| | Header-Functional- | | ObjectList-Technical- | |
|---|---|---|---|---|
| HeaderEquipment | Location | HeaderTechnicalObject | Object | Predict_Confidence |
| CFP-1001-DE | | EAMS_EQUI | EAMS_EQUI | 62 |
| | | CFP-1001-DE | CFP-1001-DE | |
| | PUMP-CFP-DE-1001 | EAMS_FLOC | 900001 | 84 |
| | | PUMP-CFP-DE-1001 | (Bearing Serialised | |
| CFP-1002-DE | | EAMS_EQUI | 4002120 | 28 |
| | | CFP-1002-DE | (Power Unit Assembly) | |
| CFP-1003-DE | | EAMS_EQUI | 4002120 | 5 |
| | | CFP-1003-DE | (Power Unit Assembly) | |
| CFP-1001-DE | | EAMS_EQUI | CFP SHAFT-1001 | 15 |
| | | CFP-1001-DE | (Serialized Material) | |
| | PUMP-CFP-DE-1001 | EAMS_FLOC | 1090001 | 37 |
| | | PUMP-CFP-DE-1001 | (Power Display Unit) | |
| | PUMP-CFP-DE-1002 | EAMS_FLOC | 4002120 | 23 |
| | | PUMP-CFP-DE-1002 | (Power Unit Assembly) | |

### Example 22—Example Architecture Overview

In any of the examples herein, a maintenance plan, maintenance item (task), the header target and assigned targets can be stored internally as data structures, tables, or the like in a computing system. In practice, each entity can be represented as a node, and relationships between nodes can be stored. Such nodes can take the form of logical objects that have properties and executable methods according to object-oriented programming paradigm. The data can be represented in data structures, database tables, or the like.

### Example 23—Example Architecture Overview

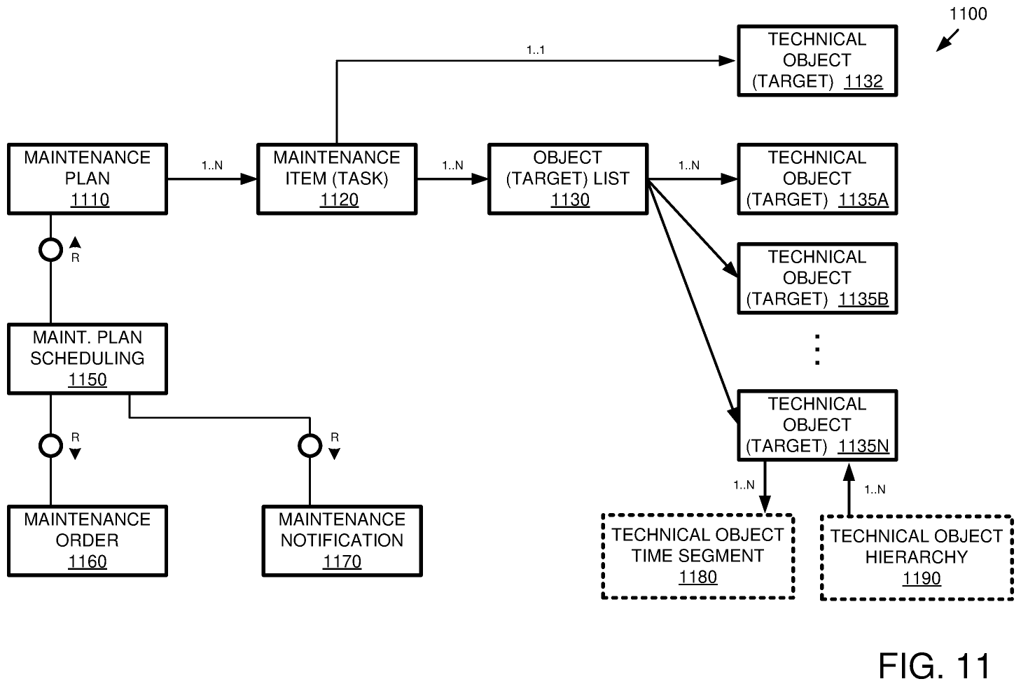

FIG. 11 is an example entity diagram 1100 of an architecture implementing the described features that can be used in any of the examples herein. In the example, a maintenance plan 1110 can have one or more associated tasks 1120. A task has a header target 1132 and an object list of one or more additional targets 1135A-N. A target (shown as a “technical object”) can be a functional location, piece of equipment, assembly, material, or material and serial number; a target type (e.g., “functional location” or enumerated type) can be stored to designate the type of target.

Maintenance plan scheduling 1150 can store scheduling information for executing the maintenance plan 1110 to generate a maintenance order 1160, a maintenance notification 1170, or both.

Preventive maintenance software can access scheduling 1150 and determine whether it is time to generate an appropriate maintenance order or maintenance notification. Schedules can be specified by date, periodicity, or the like. When the scheduling 1150 indicates that it is time to generate an order or notification, the software can access the related tasks and objects (e.g., targets) and generate an order 1160 or notification 1170. For example, an order can specify that the task is to be performed by a certain time/date on the header target 1132 and any assigned targets 1135A-N.

Technical object (e.g., target) time segments 1180 can also be stored to represent time segments (e.g., validity segments) as described herein for the targets 1132, 1135A-N. Although the diagram shows a connection to 1135N only, in practice any of the targets can have segments.

Similarly, a technical object hierarchy 1190 can place any of the targets 1132, 1135A-N in a hierarchy as described herein. For example, when a target is dismantled, its location in the hierarchy can be used to filter future recommendations.

### Example 24—Example User Interface

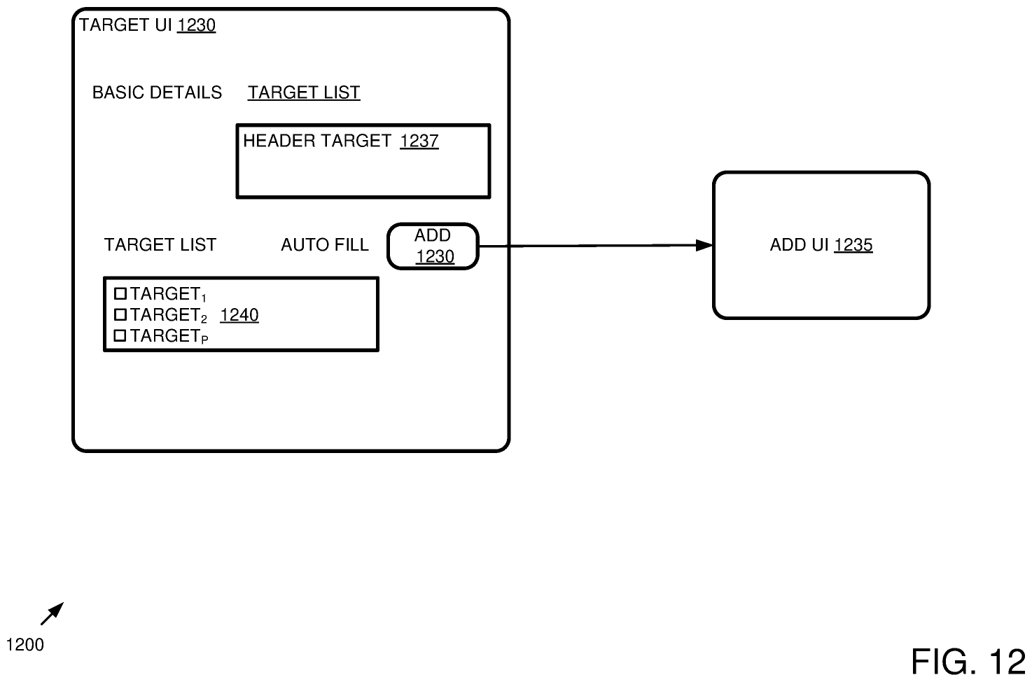

FIG. 12 is a block diagram of an example user interface 1200 implementing the described features that can be used in any of the examples herein. In the example, a target user interface 1230 displays a header target 1237. Details about the header target such as a description (“pump 504”) and type (e.g., “equipment”) can be displayed. Additional details, such as a description of the task(s) can also be included. The target list 1240 displays the current targets assigned to the task (e.g., and therefore to the header). A user interface element 1230 can be used to invoke add functionality (e.g., another user interface 1235) to add one or more targets to the target list 1240.

Although not shown, the target list 1240 can include further details, such as a confidence score or the like to enable review of the list 1240 with reference to results of machine learning predictions.

### Example 25—Example User Interface for Recommendations

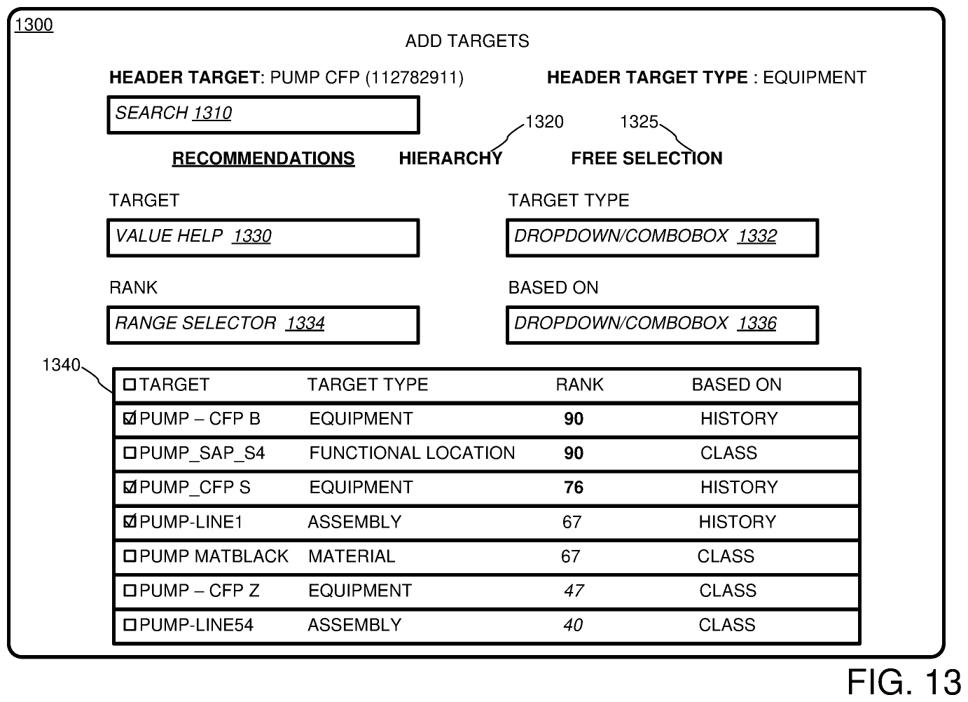

FIG. 13 is a block diagram of an example user interface 1300 displaying target recommendations according to an example recommendations format. In the example, the user interface 1300 displays a recommendations list comprising one or more recommendations 1340 that can be added by selecting them from the recommendations list 1340.

The header target and header target type are displayed along with a search option 1310. The Search option allows the user to search for maintenance targets either using the Target ID or the Description of the target. For example, “PUMP” will fetch all equipment, functional locations, and assemblies that have the name PUMP in either the ID or the description.

A user interface element 1320 can be activated to navigate away from the recommendations user interface and display a hierarchy of targets; the user interface element 1325 can be activated to navigate away from the recommendations user interface and display a user interface for free (e.g., manual) selection of targets.

User interfaces elements can be displayed to provide filters for the recommendations list 1340. For example, user interface element 1330 can be displayed to filter based on target description. When a value is entered into the box 1330, the recommendation list 1340 is filtered to show only those targets that contain or start with the value in the target description. User interface element 1332 can be displayed to filter based on target type; when a value is selected from the dropdown 1332, the recommendation list 1340 is filtered to show only those targets that are of the selected target type (e.g., equipment, functional location, or the like). User interface element 1334 can be displayed to filter based on a floor or range of confidence score; when a value or range is entered, the recommendation list 1340 is filtered to show only those targets that meet the confidence score floor or range. User interface element 1336 can be displayed to filter based on “based on” type; when one or more “based on” types are selected, the recommendation list 1340 is filtered to show only those targets that are of the selected “based on” types (e.g., “history”).

A selection of targets from the recommended targets 1340 can be achieved by selecting them (e.g., by clicking or tapping them, clicking or tapping a checkbox, or the like). A “confirm” or “OK” graphical user interface element can be displayed to receive an indication that the selection process has completed. As described herein, after selection from the targets is received, the internal representation of the task can be updated to reflect that the targets have been assigned to the task (and thereby to the header target).

As shown, the recommendations 1340 can include a list of one or more recommended targets, including a description of the target, a target type, a rank, and a “based on” type. The rank can be represented by a color, or a color can be used when displaying the rank. For example, a green color can be used to indicate higher rankings (e.g., above a “high” threshold), and red can be used for lower rankings (e.g., below a “low” threshold). Yellow can be used for those in the middle.

The recommended targets in the recommendations list can be ordered by confidence score (e.g., “rank,” “percentage,” or the like).

The “based on” type can indicate whether the recommendation was based on history (e.g., predicted by the machine learning model based on past assignments) or class (e.g., predicted by the machine learning model based on the hierarchy).

Hierarchy information about the superior equipment (equipment higher in the hierarchy) in the context of the installation/dismantling dates/duration can enhance the training model if desired.

A user interface element (e.g., graphical button or the like) activatable to display fewer filters can also be displayed. Responsive to activation, some of the filter user interface elements (e.g., 1330, 1332, 1334, 1336) can be hidden from view. A user interface element can then be displayed that is activatable to show the filters. Additional features can be incorporated in the user interface 1300.

### Example 26—Example Other User Interface for Recommendations

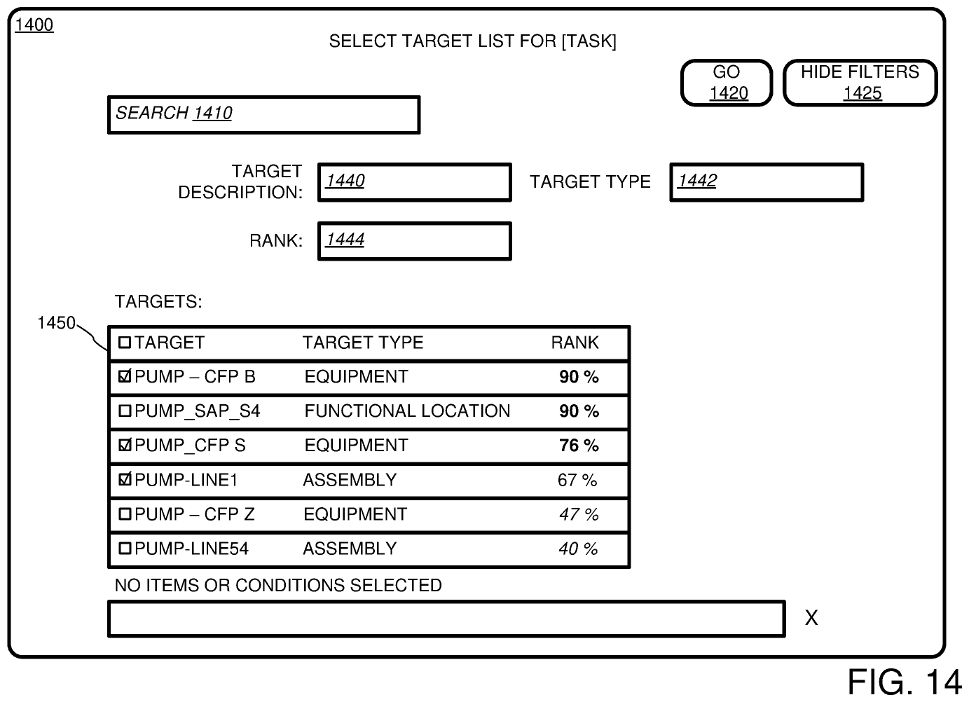

FIG. 14 is a block diagram of another example user interface 1400 receiving recommendations according to an example recommendations format. In the example, a recommendations list 1450 displays a recommendations list comprising one or more recommendations that can be added by selecting them from the recommendations list 1450.

A search option 1410 is provided, which can function similarly to that of 1310.

User interface elements can be displayed to provide filters for the recommendations list 1450. For example, the target description 1440 box can be used similar to the element 1330 of FIG. 13. The target type 1442 box can be used similar to the element 1332. The rank box 1444 can be implemented similarly to the element 1334.

As in the user interface of FIG. 13, the recommendations list 1450 can display a description, target type, and confidence score. As in the interface of FIG. 13, colors and ordering can be used in the recommendations list. Targets can be selected in a similar way.

A “go” user interface element 1420 can be used to confirm selection of the targets. As described herein, after selection from the targets is received, the internal representation of the task can be updated to reflect that the targets have been assigned to the task (and thereby to the header target).

A “hide filters” user interface element 1425 can be used to hide the filter user interface elements 1440, 1442, 1444.

Additional features can be incorporated in the user interface 1400.

### Example 27—Example Architecture (High Level)

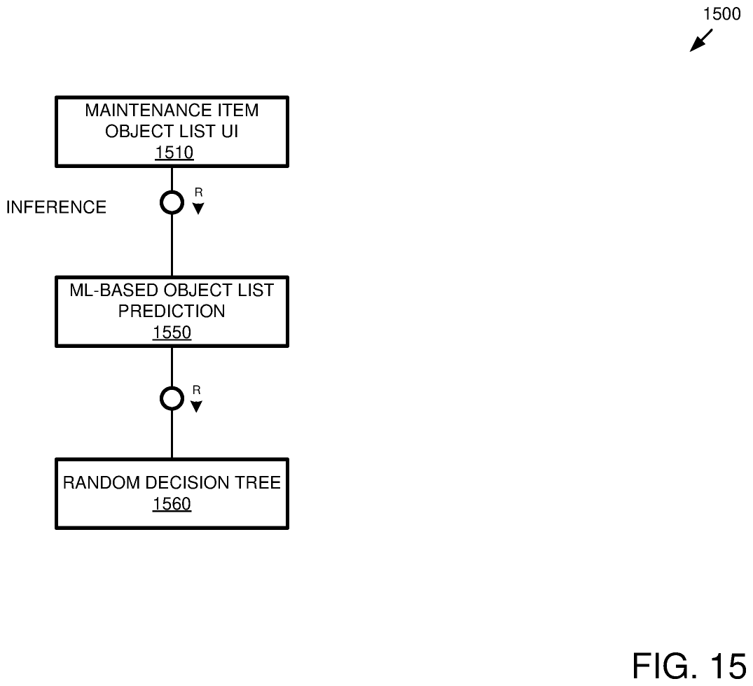

FIG. 15 is an example machine-learning-based object list diagram of an architecture 1500 that can be used in any of the examples herein. In the example, a user interface 1510 such as those described herein provides a front end to machine-learning-based target prediction functionality 1550, which is trained with observed (e.g., historical) data as described herein.

In the example, a random decision tree model 1560 is used, but other machine learning models are possible as described herein. The random decision tree model 1560 performed well in scenarios where more than one prediction (e.g., multiple targets) were possible per input header target.

In practice, the random decision tree 1560 can be implemented from the Predictive Analysis Library (“PAL”) of the HANA Database of SAP SE of Walldorf, Germany; other similar platforms can be used, whether in an Enterprise Resource Planning context or otherwise.

### Example 28—Example Architecture (More Detailed)

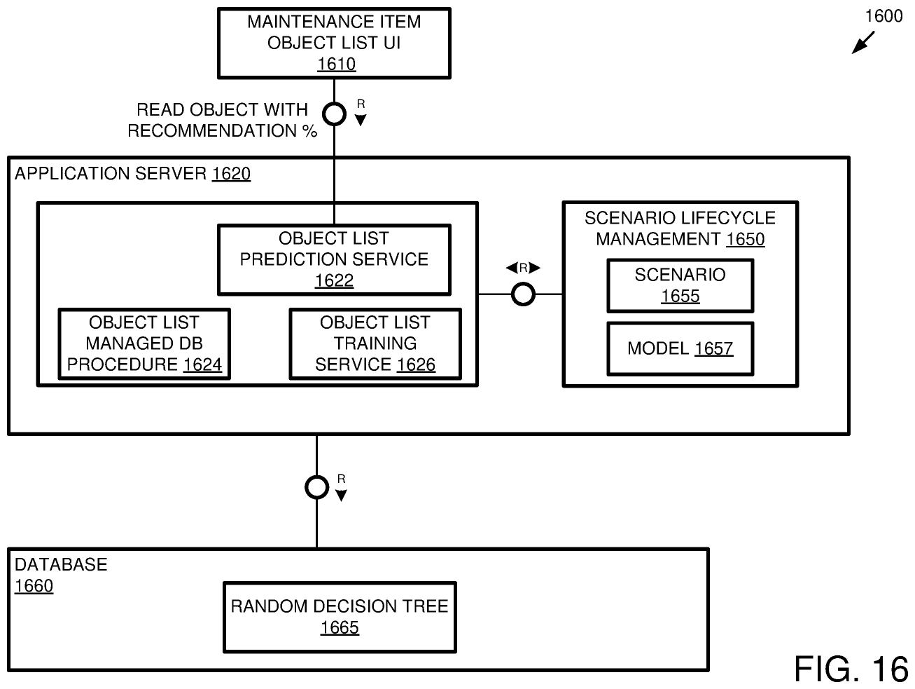

FIG. 16 is an example machine-learning-based object list diagram showing more detail of an architecture 1600 that can be used in any of the examples herein. Machine learning scenarios can be embedded in a framework to generate and train the machine learning model and generate predictions. The intelligent scenario implementation can be based on a classification model (e.g., Random Decision Tree), which can be provided by PAL via the ISLM framework. Other models can be used as described herein.

In the example, a maintenance item object list user interface 1610 (e.g., presenting a recommendations list as described herein) receives candidate targets with a confidence score (e.g., recommendation percentage, ranking, or the like) from an application server 1620.

The application server 1620 hosts (e.g., executes) an object list prediction service that outputs the predicted targets (e.g., given an input header target). The object list training service 1626 can accept training data as part of the machine learning training process, and the prediction service 1626 outputs targets according to the training service.

The object list managed database procedure 1624 can be implemented as an ABAP-managed database procedure (“AMDP”) to provide an execution mechanism for training and maintenance functions related to the training and prediction process. For example, a class can be created with a training method and predict with model version method. The training method accepts the training data and applies the model selected. For example, random decision tree (RDT) can be used as the type of model for training. Random decision tree can be used for prediction based on classification with the goal to predict/classify discrete values of objects. Other machine learning models can be used as described herein.

The object list prediction service 1622 and object list training service 1626 can be implemented as core data services. In practice, the services can appear as tables into which training data is loaded and from which predictions are queried.

Scenario lifecycle management 1650 can comprise a scenario 1655 and a model 1657. In practice, such functionality can be implemented in the Intelligent Scenario Lifecycle Management (“ISLM”) platform to provide functionality related to model and scenario management.

The random decision tree 1665 functionality can be hosted in a database 1660. For example, such functionality can be implemented from the Predictive Analysis Library (“PAL”) of the HANA Database of SAP SE of Walldorf, Germany; other similar platforms can be used, whether in an Enterprise Resource Planning context or otherwise.

### Example 29—Use Cases

The machine-learning-based technologies described herein can be applied in a variety of scenarios.

For example, a maintenance planner may be responsible for defining the maintenance plans for the targets. Such a planner is greatly assisted by having an intelligent recommendations list that shows relevant targets. When a new target is entered manually, it can eventually show up in the recommendations list as the model is updated.

A maintenance supervisor may be responsible for screening and approving/dispatching operations in the maintenance order to the relevant technicians (e.g., based on skillset/work-center capacity, and the like). Such a supervisor is greatly assisted because the targets appearing in an order can be flagged as possible errors (e.g., when the machine learning model indicates that a particular target falls below a low confidence score threshold).

A technician who may be responsible for executing maintenance orders can also avail of the technologies. Such a technician is assisted when a target appearing in the order is flagged, similar to the maintenance supervisor above.

### Example 30—Example Implementations

Any of the following can be implemented.

Clause 1. A computer-implemented method comprising:
receiving a request for a list of one or more preventive maintenance task target candidates to be assigned to a specified header preventive maintenance task target;
responsive to the request, generating a list of one or more predicted preventive maintenance task targets for assignment to the specified header preventive maintenance task target, wherein at least one of the predicted preventive maintenance task targets is predicted by a machine learning model trained with observed header preventive maintenance task targets and observed preventive maintenance task targets stored as assigned to respective of the observed header preventive maintenance task targets; and
outputting the list of the one or more predicted preventive maintenance task targets for assignment in response to the request.

Clause 2. The method of Clause 1, wherein:
the observed header preventive maintenance task targets and observed preventive maintenance task targets are structured as assigned to each other when in a same internally represented preventive maintenance task.

Clause 3. The method of Clause 2, further comprising:
training the machine learning model with the observed header preventive maintenance task targets and observed preventive maintenance task targets structured during the training as assigned to each other when in a same internally represented maintenance task.

Clause 4. The method of any one of Clauses 1-3, wherein:
at least one of the preventive maintenance task targets comprises a represented functional location.

Clause 5. The method of any one of Clauses 1-4, wherein:
at least one of the preventive maintenance task targets comprises a represented piece of equipment.

Clause 6. The method of any one of Clauses 1-5, wherein:
at least one of the preventive maintenance task targets comprises:
an assembly;
a material; or
a material and serial number.

Clause 7. The method of claim any one of Clauses 1-6, wherein:
the trained machine learning model outputs a confidence score of a particular target that the particular target would be assigned to a particular header target.

Clause 8. The method of any one of Clauses 1-7, wherein:
the specified header preventive maintenance task target is of a task of a user interface configured to assign one or more preventive maintenance task targets to the task based on the specified header preventive maintenance task target; and
the method further comprises:
displaying the list of the one or more predicted preventive maintenance task targets in the user interface as recommended;
receiving a selection of one or more selected preventive maintenance task targets out of the one or more predicted preventive maintenance task targets; and
assigning the one or more selected preventive maintenance task targets to the task of the user interface.

Clause 9. The method of Clause 8, wherein:
the list of the one or more predicted preventive maintenance task targets in the user interface indicates whether a given displayed preventive maintenance task target is based on history or class.

Clause 10. The method of any one of Clauses 8-9, wherein:
generating the list of one or more predicted preventive maintenance task targets for assignment comprises filtering the list with a threshold confidence score.

Clause 11. The method of any one of Clauses 8-10, wherein:
generating the list of one or more predicted preventive maintenance task targets for assignment comprises ranking the list by confidence score.

Clause 12. The method of any one of Clauses 8-11, further comprising:
filtering the list of one or more predicted preventive maintenance task targets, wherein the filtering removes dismantled predicted preventive maintenance task targets.

Clause 13. The method of Clause 12, wherein:
the filtering is performed via validity segments.

Clause 14. The method of any one of Clauses 8-13, further comprising:
receiving a manually-entered preventive maintenance task target not on the list of the one or more predicted preventive maintenance task targets; and
assigning the one or more selected preventive maintenance task targets to the task of the user interface.

Clause 15. The method of any one of Clauses 1-14, further comprising:
receiving a list of one or more particular preventive maintenance task targets assigned to a particular header preventive maintenance task target;
for a given particular preventive maintenance task target out of the particular preventive maintenance task targets, comparing a confidence score computed by a trained machine learning model against a confidence score threshold; and
outputting particular preventive maintenance task targets not meeting the confidence score threshold as outliers.

Clause 16. A computing system comprising:
at least one hardware processor;
at least one memory coupled to the at least one hardware processor;
a stored internal representation of preventive maintenance tasks to be performed on maintenance task targets;
a machine learning model trained with observed header preventive maintenance task targets and preventive maintenance task targets observed as assigned to respective of the observed header preventive maintenance task targets; and
one or more non-transitory computer-readable media having stored therein computer-executable instructions that, when executed by the computing system, cause the computing system to perform:
receiving a request for a list of one or more preventive maintenance task target candidates to be assigned to a specified header preventive maintenance task target;
responsive to the request, generating a list of one or more predicted preventive maintenance task targets for assignment to the specified header preventive maintenance task target, wherein at least one of the predicted preventive maintenance task targets is predicted by the machine learning model trained with observed header preventive maintenance task targets and observed preventive maintenance task targets assigned to respective of the observed header preventive maintenance task targets; and
outputting the list of the one or more predicted preventive maintenance task targets for assignment in response to the request.

Clause 17. The system of Clause 16, wherein:
at least one of the preventive maintenance task targets comprises a represented functional location or a represented piece of equipment.

Clause 18. The system of any one of Clauses 16-17, further comprising:
a user interface displaying the list of one or more predicted preventive maintenance task targets for assignment to the specified header preventive maintenance task target, where in the list is ordered by confidence score.

Clause 19. The system of any one of Clauses 16-18, wherein:
the machine learning model comprises a binary decision tree model.

Clause 20. One or more non-transitory computer-readable media comprising computer-executable instructions that, when executed by a computing system, cause the computing system to perform operations comprising:
for a specified header preventive maintenance task target to which a represented preventive maintenance task is directed, receiving a request for one or more preventive maintenance task target candidates to be included with the specified header preventive maintenance task target;
applying the specified header preventive maintenance task target and an equipment class or equipment type of the specified header preventive maintenance task target to a machine learning model;
receiving a prediction from the machine learning model, wherein the prediction comprises one or more proposed preventive maintenance task targets predicted to be associated with the specified header preventive maintenance task target;
displaying at least a subset of the proposed preventive maintenance task targets predicted to be associated with the specified header preventive maintenance task target;
receiving a selection of one or more selected proposed preventive maintenance task targets out of the displayed proposed preventive maintenance task targets; and
storing an association between the selected proposed preventive maintenance task targets and the represented preventive maintenance task, thereby adding the selected proposed preventive maintenance task targets as targets of the represented preventive maintenance task.

Clause 21. One or more non-transitory computer-readable media comprising computer-executable instructions that, when executed by a computing system, cause the computing system to perform the method of any one of the Clauses 1-15.

### Example 31—Example Advantages

A number of advantages can be achieved via the technologies described herein. For example, because the recommendations list is presented in the preventive maintenance application, there is no need to go to a different application (e.g., a bill of material or asset viewer application) to correlate the targets being entered.

Data integrity is improved. Only relevant targets are included in the recommendations list. When structure changes, the recommendations list can be updated (e.g., by re-training or updating the model).

Machine learning features can be used to better learn which targets should appear. Non-linear models can identify situations and make predictions that a human operator would be likely to overlook.

Such technologies can greatly reduce the number of errors, leading to more widespread use of preventive maintenance automation in various domains.

As a result, the technologies can avoid the unnecessary expenditure of preventive maintenance resources due to mistaken maintenance orders or notifications (e.g., performing maintenance on a piece of equipment that was not needed due to an entry error).

Finally, a well-orchestrated preventive maintenance plan as carried out by the technologies described herein can avoid injury caused by failure of equipment that was not properly maintained (e.g., due to waste or misallocation of resources).

### Example 32—Example Computing Systems

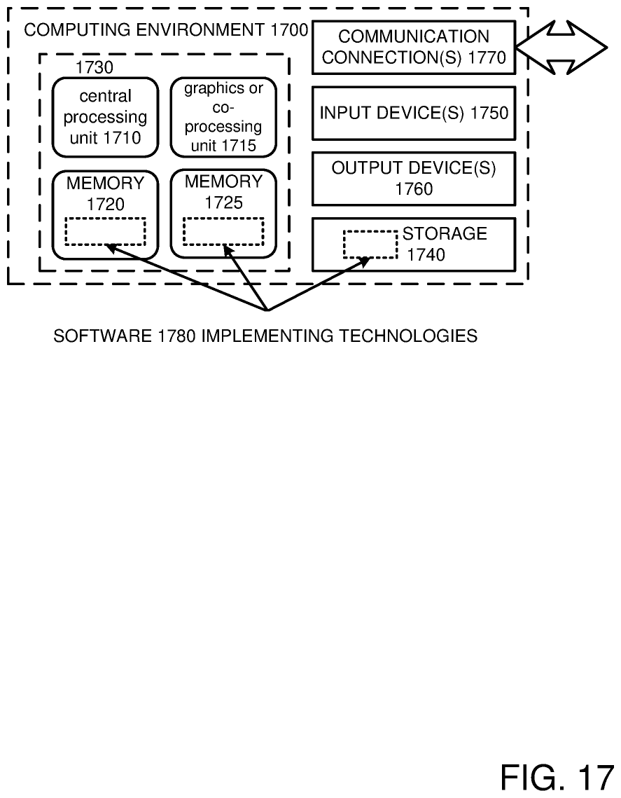

FIG. 17 depicts an example of a suitable computing system 1700 in which the described innovations can be implemented. The computing system 1700 is not intended to suggest any limitation as to scope of use or functionality of the present disclosure, as the innovations can be implemented in diverse computing systems.

With reference to FIG. 17, the computing system 1700 includes one or more processing units 1710, 1715 and memory 1720, 1725. In FIG. 17, this basic configuration 1730 is included within a dashed line. The processing units 1710, 1715 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 17 shows a central processing unit 1710 as well as a graphics processing unit or co-processing unit 1715. The tangible memory 1720, 1725 can be volatile memory (e.g., registers, cache, RAM), non-volatile memory (e.g., ROM, EEPROM, flash memory, etc.), or some combination of the two, accessible by the processing unit(s) 1710, 1715. The memory 1720, 1725 stores software 1780 implementing one or more innovations described herein, in the form of computer-executable instructions suitable for execution by the processing unit(s) 1710, 1715.

A computing system 1700 can have additional features. For example, the computing system 1700 includes storage 1740, one or more input devices 1750, one or more output devices 1760, and one or more communication connections 1770, including input devices, output devices, and communication connections for interacting with a user. An interconnection mechanism (not shown) such as a bus, controller, or network interconnects the components of the computing system 1700. Typically, operating system software (not shown) provides an operating environment for other software executing in the computing system 1700, and coordinates activities of the components of the computing system 1700.

The tangible storage 1740 can be removable or non-removable, and includes magnetic disks, magnetic tapes or cassettes, CD-ROMs, DVDs, or any other medium which can be used to store information in a non-transitory way and which can be accessed within the computing system 1700. The storage 1740 stores instructions for the software 1780 implementing one or more innovations described herein.

The input device(s) 1750 can be an input device such as a keyboard, mouse, pen, or trackball, a voice input device, a scanning device, touch device (e.g., touchpad, display, or the like) or another device that provides input to the computing system 1700. The output device(s) 1760 can be a display, printer, speaker, CD-writer, or another device that provides output from the computing system 1700.

The communication connection(s) 1770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 33—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 34—Example Cloud Computing Environment

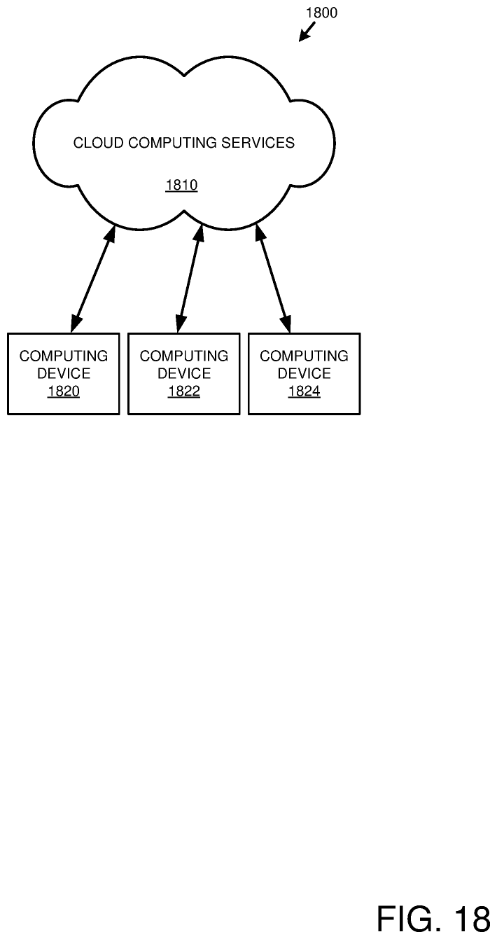

FIG. 18 depicts an example cloud computing environment 1800 in which the described technologies can be implemented, including, e.g., the system 100 of FIG. 1 and other systems herein. The cloud computing environment 1800 comprises cloud computing services 1810. The cloud computing services 1810 can comprise various types of cloud computing resources, such as computer servers, data storage repositories, networking resources, etc. The cloud computing services 1810 can be centrally located (e.g., provided by a data center of a business or organization) or distributed (e.g., provided by various computing resources located at different locations, such as different data centers and/or located in different cities or countries).

The cloud computing services 1810 are utilized by various types of computing devices (e.g., client computing devices), such as computing devices 1820, 1822, and 1824. For example, the computing devices (e.g., 1820, 1822, and 1824) can be computers (e.g., desktop or laptop computers), mobile devices (e.g., tablet computers or smart phones), or other types of computing devices. For example, the computing devices (e.g., 1820, 1822, and 1824) can utilize the cloud computing services 1810 to perform computing operations (e.g., data processing, data storage, and the like).

In practice, cloud-based, on-premises-based, or hybrid scenarios can be supported.

### Example 35—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 36—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a request for a list of one or more preventive maintenance task target candidates to be assigned to a specified header preventive maintenance task target;
responsive to the request, generating a list of one or more predicted preventive maintenance task targets for assignment to the specified header preventive maintenance task target, wherein at least one of the predicted preventive maintenance task targets is predicted by a machine learning model trained with observed header preventive maintenance task targets and observed preventive maintenance task targets stored as assigned to respective of the observed header preventive maintenance task targets; and
outputting the list of the one or more predicted preventive maintenance task targets for assignment in response to the request.

2. The method of claim 1, wherein:
the observed header preventive maintenance task targets and observed preventive maintenance task targets are structured as assigned to each other when in a same internally represented preventive maintenance task.

3. The method of claim 2, further comprising:
training the machine learning model with the observed header preventive maintenance task targets and observed preventive maintenance task targets structured during the training as assigned to each other when in a same internally represented maintenance task.

4. The method of claim 1, wherein:
at least one of the preventive maintenance task targets comprises a represented functional location.

5. The method of claim 1, wherein:
at least one of the preventive maintenance task targets comprises a represented piece of equipment.

6. The method of claim 1, wherein:
at least one of the preventive maintenance task targets comprises:
an assembly;
a material; or
a material and serial number.

7. The method of claim 1, wherein:
the trained machine learning model outputs a confidence score of a particular target that the particular target would be assigned to a particular header target.

8. The method of claim 1, wherein:
the specified header preventive maintenance task target is of a task of a user interface configured to assign one or more preventive maintenance task targets to the task based on the specified header preventive maintenance task target; and
the method further comprises:
displaying the list of the one or more predicted preventive maintenance task targets in the user interface as recommended;
receiving a selection of one or more selected preventive maintenance task targets out of the one or more predicted preventive maintenance task targets; and
assigning the one or more selected preventive maintenance task targets to the task of the user interface.

9. The method of claim 8, wherein:
the list of the one or more predicted preventive maintenance task targets in the user interface indicates whether a given displayed preventive maintenance task target is based on history or class.

10. The method of claim 8, wherein:
generating the list of one or more predicted preventive maintenance task targets for assignment comprises filtering the list with a threshold confidence score.

11. The method of claim 8, wherein:
generating the list of one or more predicted preventive maintenance task targets for assignment comprises ranking the list by confidence score.

12. The method of claim 8, further comprising:
filtering the list of one or more predicted preventive maintenance task targets, wherein the filtering removes dismantled predicted preventive maintenance task targets.

13. The method of claim 12, wherein:
the filtering is performed via validity segments.

14. The method of claim 8, further comprising:
receiving a manually-entered preventive maintenance task target not on the list of the one or more predicted preventive maintenance task targets; and
assigning the one or more selected preventive maintenance task targets to the task of the user interface.

15. The method of claim 1, further comprising:
receiving a list of one or more particular preventive maintenance task targets assigned to a particular header preventive maintenance task target;
for a given particular preventive maintenance task target out of the particular preventive maintenance task targets, comparing a confidence score computed by a trained machine learning model against a confidence score threshold; and
outputting particular preventive maintenance task targets not meeting the confidence score threshold as outliers.

16. A computing system comprising:
at least one hardware processor;
at least one memory coupled to the at least one hardware processor;
a stored internal representation of preventive maintenance tasks to be performed on maintenance task targets;
a machine learning model trained with observed header preventive maintenance task targets and preventive maintenance task targets observed as assigned to respective of the observed header preventive maintenance task targets; and
one or more non-transitory computer-readable media having stored therein computer-executable instructions that, when executed by the computing system, cause the computing system to perform:
receiving a request for a list of one or more preventive maintenance task target candidates to be assigned to a specified header preventive maintenance task target;
responsive to the request, generating a list of one or more predicted preventive maintenance task targets for assignment to the specified header preventive maintenance task target, wherein at least one of the predicted preventive maintenance task targets is predicted by the machine learning model trained with observed header preventive maintenance task targets and observed preventive maintenance task targets assigned to respective of the observed header preventive maintenance task targets; and
outputting the list of the one or more predicted preventive maintenance task targets for assignment in response to the request.

17. The system of claim 16, wherein:
at least one of the preventive maintenance task targets comprises a represented functional location or a represented piece of equipment.

18. The system of claim 16, further comprising:
a user interface displaying the list of one or more predicted preventive maintenance task targets for assignment to the specified header preventive maintenance task target, where in the list is ordered by confidence score.

19. The system of claim 16, wherein:
the machine learning model comprises a binary decision tree model.

20. One or more non-transitory computer-readable media comprising computer-executable instructions that, when executed by a computing system, cause the computing system to perform operations comprising:
for a specified header preventive maintenance task target to which a represented preventive maintenance task is directed, receiving a request for one or more preventive maintenance task target candidates to be included with the specified header preventive maintenance task target;
applying the specified header preventive maintenance task target and an equipment class or equipment type of the specified header preventive maintenance task target to a machine learning model;
receiving a prediction from the machine learning model, wherein the prediction comprises one or more proposed preventive maintenance task targets predicted to be associated with the specified header preventive maintenance task target;
displaying at least a subset of the proposed preventive maintenance task targets predicted to be associated with the specified header preventive maintenance task target;
receiving a selection of one or more selected proposed preventive maintenance task targets out of the displayed proposed preventive maintenance task targets; and
storing an association between the selected proposed preventive maintenance task targets and the represented preventive maintenance task, thereby adding the selected proposed preventive maintenance task targets as targets of the represented preventive maintenance task.
